(19) United States
(12) Patent Application Publication
(10) Pub. No.: US 2024/0215593 A1
(43) Pub. Date: Jul. 4, 2024

(54) SYSTEM AND TRACK FOR MANUAL AND/OR AUTOMATIC HANDLING OF FRAMES IN PARTICULAR FOR HANDLING AND/OR PRESERVING MEATS AND /OR CURED MEATS

(71) Applicant: TECSAL S.P.A., Modesano(PR) (IT)

(72) Inventor: Stefano SONCINI, Medesano (PR) (IT)

(73) Assignee: TECSAL S.P.A., Medesano (PR) (IT)

(21) Appl. No.: 18/195,499

(22) Filed: May 10, 2023

(30) Foreign Application Priority Data
Dec. 28, 2022 (IT) 102022000027051

(51) Int. Cl. A22C 17/00

(52) U.S. Cl. CPC A22C 17/0093

(57) ABSTRACT

An overhead system for the manual and/or automatic movement of frames in particular for moving and/or storing meat and/or cold cuts, in which the frames are moved from one location to another by hooking them to a trolley-mounted device sliding along a track, the track includes first and second guideways arranged side-by-side in a transverse direction and arranged at a distance from each other to form a gap sufficient to allow passage of one or more trolley-mounted devices, which are slidably engaged on an upper surface of the guideways and protrude through the gap below the guideways to receive the frames. The first and second guideways have an open cross-sectional profile having an opening and are arranged side-by-side so that the opening faces outwards defining a track with open outer sidewalls.

### FIELD OF THE INVENTION

The present invention falls within the field of equipment for the overhead or suspended movement of frames suitable for moving and/or storing meat, cold cuts and semi-finished products in production/processing lines, e.g., hams, sausages, bacon, etc.

### BACKGROUND

In general, products such as cold cuts and/or meat that arrive fresh by truck are first transferred to temporary storage rooms where they are sorted and then transferred to processing rooms for the subsequent salting, drying and storage phase.

These products are generally placed on or hung on frames and/or racks. Overhead systems for the automatic or manual movement of such frames and/or racks supporting one or more products to be moved in production/processing lines are known in the state of the art.

Such movement systems generally involve moving these frames and/or racks from one location to another by hooking them onto a trolley-mounted device sliding along a track.

These tracks extend along a given route and are of the overhead type, i.e., arranged in an elevated position above the ground.

For example, they can be placed near ceilings and supported by anchoring them directly to the structure of the plant.

Generally, a plurality of trolley-mounted devices run on the track.

The frames or racks are hooked underneath these tracks to the trolley-mounted devices and therefore positioned below the track facing the ground.

These tracks generally include a guideway on which the trolley-mounted device is engaged. Known guideways must be resistant to applied loads that can reach high values.

Increasingly, there is a requirement that these guideways be cleanable, e.g., able to be sanitized or washed to meet hygiene regulations for food production environments.

An example of a well-known and widely used guideway, which responds very well to torsion and bending stresses due to applied loads, comprises an extruded aluminum profile.

Said internally hollow extruded aluminum profile is shaped with reinforcements at the points of greatest stress and includes two horizontal wings facing downwards.

Within this extruded profile, the trolley-mounted device is engaged, and in particular the sliding elements, which may be, for example, rollers, or bearings, or sliding blocks, etc. These sliding elements engage smoothly with the two horizontal wings.

The trolley-mounted device protrudes from the extruded profile through a slot between the two horizontal wings and protrudes below said guideway with a hooking element suitable for receiving frames and/or racks.

Said extruded profile is an almost completely closed profile minus the slit and therefore difficult to clean and can retain dirt on the horizontal wings.

Said extruded profile is made of aluminum. Aluminum may be susceptible to corrosion when food-grade washing is performed. Therefore, this extruded profile is suitable in working environments where there is no need to wash the equipment or where there are no stringent hygienic requirements for foodstuffs.

Moreover, aluminum is a material that is not always allowed in the food industry in all countries. Food regulations often prescribe the use of stainless steel. In fact, stainless steel is a particularly suitable material that can be washed and sanitized without damage and is therefore one of the most suitable materials in the food industry.

The same extruded profile previously made of aluminum could not be made of stainless steel, as the reinforcements present and the shape of the profile would have resulted in a track too heavy to support.

Moreover, the machining required to obtain said stainless steel profile would have required high manufacturing costs. To overcome this problem, tracks, particularly made of stainless steel, were designed with different profiles. For example, tracks made using one or more side-by-side tubular profiles are known to the state of the art.

This solution is robust and simple to implement.

These tracks, however, require holes or welding in order to be installed. The presence of such holes or welds is particularly critical during washing, as water can enter the inside of the tube and, if unable to escape, can cause stagnation and contamination.

Therefore, closed tubular profiles, which have the advantage of good mechanical strength, have the limitations described above.

It is therefore necessary to devise a track designed to ensure a low track weight in order to avoid overloading the supporting structures, good mechanical resistance to applied loads, and a conformation that can satisfy the hygienic aspects of the movement equipment.

These different technical requirements may be at odds with each other. In fact, closed-section profiles have greater mechanical strength, but are heavier and not hygienically safe.

In contrast, open profiles have less mechanical resistance, but are easier to clean.

### SUMMARY

The technical problem underlying the present invention is to provide an overhead system and associated track for the manual and/or automatic movement of frames in particular for moving and/or storing meat and/or cold cuts which provides a track having a conformation that simultaneously allows for good mechanical resistance to applied loads and a conformation suitable for being clean and not retaining dirt.

A further aim of the invention is also to make available to the state of the art an overhead system for the manual and/or automatic movement of frames, in particular for moving and/or storing meat and/or cold cuts, within the scope of a simple, rational and rather inexpensive solution.

In particular, the subject matter of the invention is an overhead system for the manual and/or automatic movement of frames in particular for moving and/or storing meat and/or cold cuts which provides for moving said frames from one location to another by hooking them to a trolley-mounted device sliding along a track.

Preferably this track comprises a first and a second guideway arranged side by side in a transverse direction.

Preferably, said first and second guideways are arranged at a distance from each other to form a gap sufficient to allow the passage of one or more trolley-mounted devices which are slidably engaged on an upper surface of said guideways and protrude through the gap below said guideways to receive the frames.

Preferably, said first and second guideways have a profile with an open cross-section comprising an opening.

Preferably said first and second guideways are arranged side-by-side so that said opening faces outwards defining a track with open outer sidewalls.

Preferably said first guideway has the same cross-sectional area as the second guideway.

Preferably said track comprises the first and second guideways arranged mirrored with respect to an axis central to the gap.

Advantageously, said opening extends substantially along the entire length of said first and second guideway.

Preferably, the upper surface of the first and second guideway are arranged on the same plane.

Preferably said first and/or second guideway comprises a lower surface opposed to the upper surface.

Preferably the lower surface is parallel to the upper surface.

Preferably, the lower surface and the upper surface are connected to each other by means of a connecting surface arranged orthogonally to said upper surface and/or lower surface.

Preferably, in said track the connecting surface of the first guideway is flanked by the connecting surface of the second guideway.

Optionally, said first and/or second guideway comprises a lip extending from the lower surface towards the upper surface, defining the height of the opening and/or extending from the upper surface towards the lower surface defining the height of the opening.

Preferably said first and/or second guideway is formed by a single piece preferably by bending a sheet metal.

Preferably, the trolley-mounted device comprises at least one pair of sliding elements each adapted to be engaged resting on the upper surface of the respective first and/or second guideway.

Preferably, said track comprises a plurality of joining elements connecting the first guideway to the second guideway in a side-by-side position and preferably configured to be engaged on the outer sidewalls of the track.

Preferably, said joining element is shaped like a “U” overturned by 180° which embraces the track on the outer sidewalls and extends above the track, leaving free space for the movement of the pair of sliding elements of the trolley-mounted device.

Preferably this joining element is made of open-section profiles to facilitate washing and not retain dirt.

Preferably, the system comprises means for supporting the track, extending above the track and/or along at least a portion of said track, preferably being mechanically connected to the joining elements.

Preferably, the support means comprise a first and a second support element arranged side-by-side in a transverse direction and preferably arranged spaced apart to form a gap, wherein said first and second support elements have an open cross-sectional profile comprising a slot and are arranged so that said slot faces the outside of the support means.

Preferably said first and second support element has the same cross-sectional area as the first and second guideway.

Preferably, said first and second support elements comprise one or more reinforcing elements preferably inserted within its cross-section.

Preferably such support means comprise fixing means for installation in the plant.

Preferably, the track and/or said support means, and/or said joining elements are made of stainless steel.

The subject matter of the invention is also a track for systems (10) for the manual and/or automatic movement of frames in particular for moving and/or storing meat and/or cold cuts which provides for moving said frames from one location to another by hooking them to a trolley-mounted device sliding along said track.

These and other objects are reached by the characteristics of the invention as set forth in the appended claims. Said objects and advantages are all achieved by the overhead system for the manual and/or automatic movement of frames in particular for moving and/or storing meats and/or cold cuts, according to the present invention, which is set forth in the appended claims.

### BRIEF DESCRIPTION OF THE DRAWINGS

These and other features will be more apparent from the following description of certain embodiments illustrated by way of non-limiting example in the accompanying drawings.

FIG. 1a: illustrates an axonometric view of an overhead system for the manual and/or automatic movement of frames complete with track, trolley-mounted device and support means;

FIG. 1b: illustrates a side view of an overhead system for the manual and/or automatic movement of frames complete with track, trolley-mounted device and support means;

FIG. 1c: illustrates a front view of an overhead system for the manual and/or automatic movement of frames complete with track, trolley-mounted device and support means;

FIG. 2a: illustrates an axonometric view of the track of an overhead system for the manual and/or automatic movement of frames;

FIG. 2b: illustrates a side view of the track of an overhead system for the manual and/or automatic movement of frames;

FIG. 2c: illustrates a front view of the track of an overhead system for the manual and/or automatic movement of frames.

### DETAILED DESCRIPTION OF THE PREFERRED EMBODIMENTS

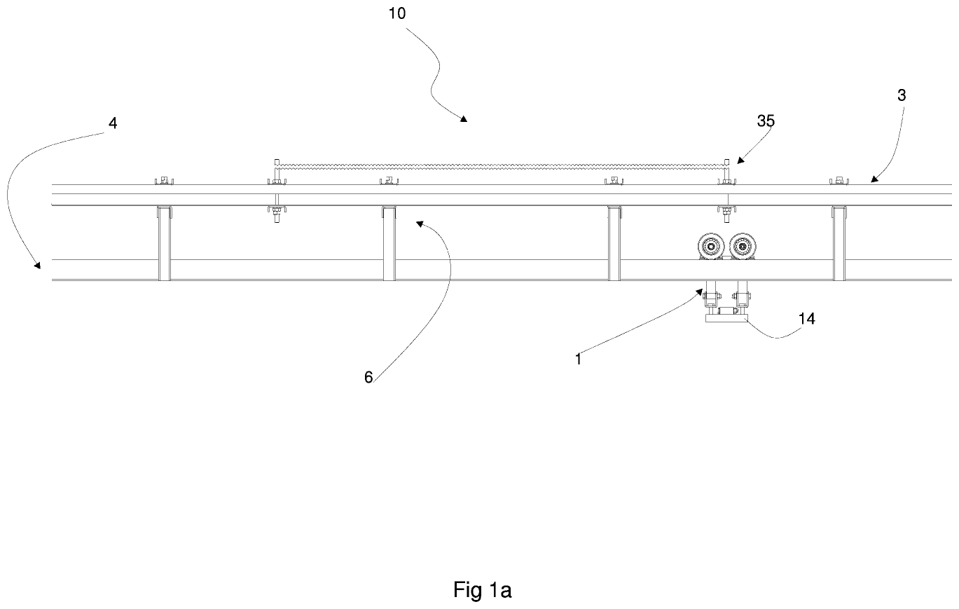

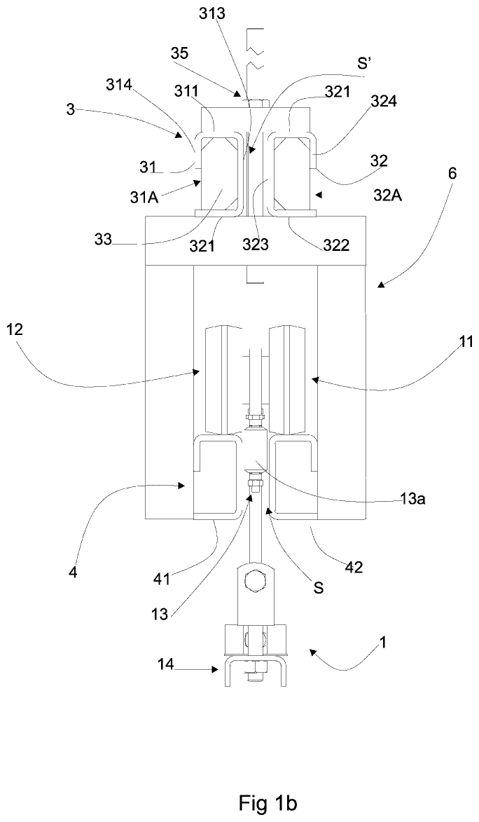

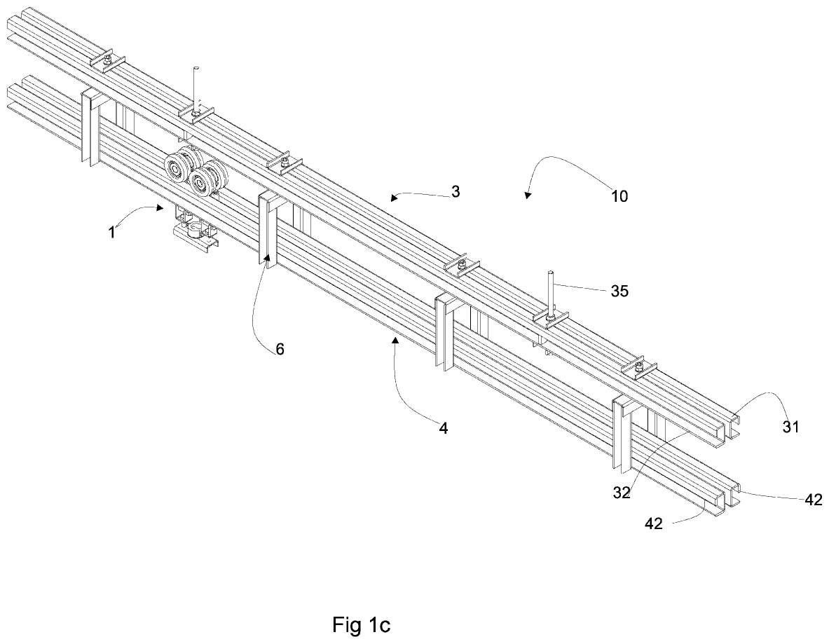

With particular reference to FIG. 1, an overhead system 10 is shown for the manual and/or automatic movement of frames, not shown in the figure, in particular for moving and/or storing meat and/or cold cuts.

Said system 10 provides for moving said frames from one location to another by hooking them to a trolley-mounted device 1 sliding along a track 4.

Said frames, also known as racks, can be shaped in various ways to support the products in a suspended or supported manner.

We will not go into the details of these frames as they are known to a person skilled in the art. However, an example is shown in the figures.

According to a preferred embodiment, said track 4 comprises a first and a second guideway 41, 42.

The term ‘guideway’ refers to a rail configured to allow the trolley-mounted device 1 to slide.

The track 4 generally extends parallel to the ground, but there may also be inclined sections that define an uphill or downhill path.

Generally, a plurality of trolley-mounted devices 1 run on the track 4. The frames are hooked onto the trolley-mounted devices 1 and positioned below the track 4, facing the ground.

According to one aspect of the invention, the first and second guideways 41, 42 are arranged side by side in a transverse direction.

In particular, they are flanked along the entire length of the track 4. Preferably said first and second guideways 41, 42 are arranged on the same plane so as to create a support surface on the same level.

Advantageously, said first and second guideways 41, 42 are arranged at a distance from each other to form a gap S sufficient to allow the passage of the trolley-mounted device 1.

In fact, the trolley-mounted device 1 exits through the gap S below said guideways 41, 42 to receive the frames below the track 4.

In particular, said trolley-mounted device 1 comprises at least one pair of sliding elements 11, 12 each adapted to be engaged resting on the respective first and/or second guideway 41, 42.

Preferably said trolley-mounted device 1 further comprises an extension 13 connecting the sliding elements 11, 12 with a hooking element 14 configured to receive the frames 15.

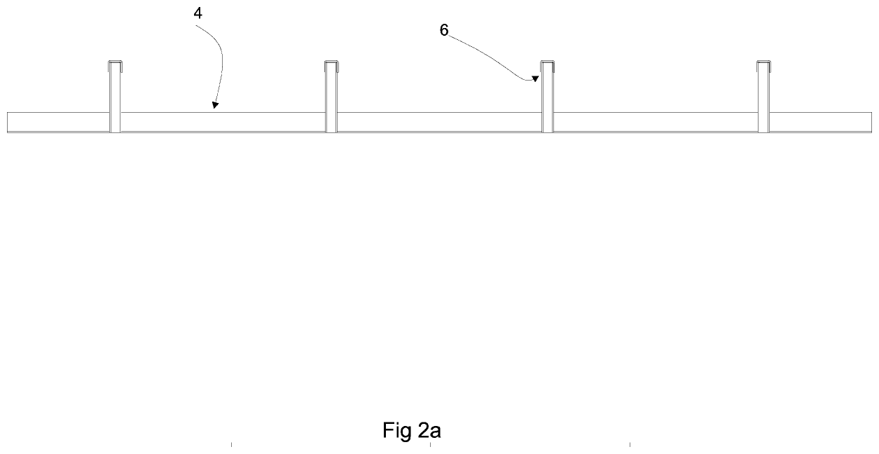

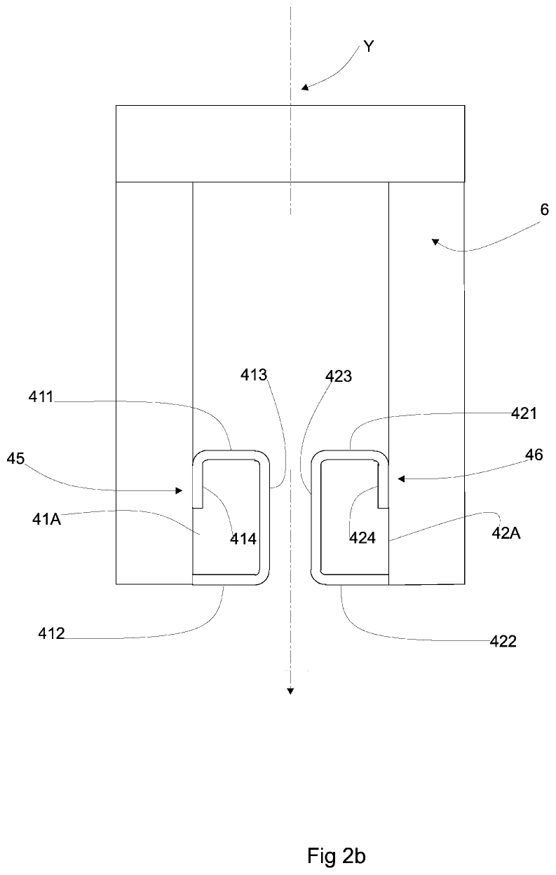

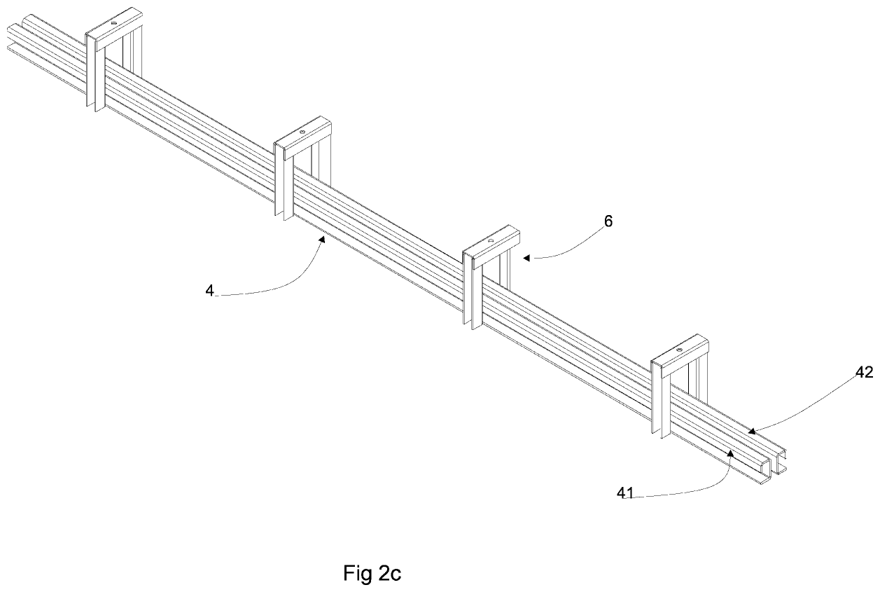

As depicted in FIG. 2b preferably the trolley-mounted device 1 engages in a sliding manner on an upper surface 411, 421 of said guideways 41, 42.

In particular, said pair of sliding elements 11, 12 is adapted to engage in support on the upper surface 411, 421 of the respective first and/or second guideway 41, 42. The figure shows an embodiment in which there are two pairs of sliding elements 11, 12. Said sliding elements 11, 12 can be sliding blocks, or rollers as depicted in the figure.

According to an advantageous aspect of the invention said first and second guideways 41, 42 have a profile with an open cross-section.

Thanks to this solution, it is possible to clean the track 4 by draining the dirt or washing products from said open profile.

In particular, each first and second guideway 41, 42 comprises an opening 41A, 42A (FIG. 2b). Preferably, said opening 41A, 42A extends substantially along the entire length of said first and second guideway 41, 42.

This facilitates cleaning along the entire length of the path without leaving closed areas where it is difficult to intervene. According to a preferred embodiment, said first and second tracks 41, 42 are arranged so that said opening 41A, 42A faces outwards defining a track with open outer sidewalls 45, 46.

This also promotes the cleaning of the track 4 by allowing work on the more accessible outer sides. An advantageous aspect of the invention is that said first guideway 41 has the same cross-sectional area as the second guideway 42.

This allows production costs to be reduced by always using the same profiled materials. As depicted in FIG. 1b, said track 4 comprises the first and second guideways 41, 42 arranged mirrored with respect to an axis Y central to the gap S.

As described above, said first and second guideways 41, 42 can be arranged on the same plane so as to create a support surface on the same level. In that case in particular the upper surface 411, 421 of the first and second guideway 41, 42 is arranged on the same plane.

The figures show a preferred embodiment in which said first and/or second guideway 41, 42 comprises a lower surface 412, 422 opposed and preferably parallel to the upper surface 411, 421.

Furthermore, preferably said lower surface 412, 422 and upper surface 411, 421, are connected to each other by a connecting surface 413, 423 arranged orthogonally to said upper surface 411, 421 and/or lower surface 412, 422.

In the track 4, the side-by-side arrangement of the first and second guideway 41, 42 is preferably realized by arranging the connecting surface 413 of the first guideway 41 side-by-side with the connecting surface 423 of the second guideway 42.

In particular, the connecting surface 413 of the first guideway 41 and the connecting surface 423 of the second guideway 42 are spaced by the gap S, for the passage of the trolley-mounted device 1.

In particular, the extension 13 passes through said gap S to below the track 4 from which it protrudes.

Therefore, during the movement of the trolley-mounted device 1, along the track 4, the extension 13 can come into contact with the guideways 41, 42 in particular with the connecting surface 413, 423.

In order to improve the sliding of the trolley-mounted device 1 and to avoid wear or snagging, said extension 13 can comprise sliding components 13a, as shown in FIG. 1b.

For example, said sliding components 13A can be rollers that contact the guideways 41, 42 in particular the connecting surface 413, 423.

Optionally said first and/or second guideway 41, 42 comprises a lip 414, 424 extending from the lower surface 412, 422 towards the upper surface 411, 421, defining the height of the opening 41A, 42A.

Optionally said first and/or second guideway 41, 42 comprises a lip 414, 424 extending from the upper surface 411, 421 towards the lower surface 412, 422 defining the height of the opening 41A, 42A.

Accordingly, said first and/or second guideways 41, 42 may comprise two lips 414, 424 and be C-shaped, or no lips 414, 424 being shaped like a “U” turned by 90°, or with only one lip 414, 424 being shaped like the solution shown in FIG. 2b.

This particular configuration is an excellent compromise to meet the various requirements to be fulfilled by the track 4 and therefore the guideways 41, 42.

In fact, the solution shown in FIG. 2b makes it possible to realize a guideway 41, 42 with an open profile, but with good resistance to bending and torsion; further, having only one lip 414, 424, the guideway 41, 42 does not have an excessive weight.

In addition, placing the two guideways 41, 42 side by side makes it possible to obtain a track 4 with a cross-section with a significantly higher resistance to torsion than the single guideway 41. 42.

Advantageously, each first and/or second guideway 41, 42 is formed by a single piece, preferably by bending a sheet metal.

This results in a low production cost solution.

The plate thickness is preferably comprised between 2 and 6 mm depending on the length of the track 4 and the loads applied.

Advantageously, said first and/or second guides 41, 42 are made of stainless steel to allow for a longer service life when subjected to washing and/or sanitizing treatments.

According to a preferred aspect, said track 4 comprises a plurality of joining elements 6 connecting the first guideway 41 to the second guideway 42 so that they are arranged side by side.

Preferably, as depicted in the figures, said joining elements 6 are configured to engage the outer sidewalls 45, 46 of the track 4.

Said joining elements 6 may be welded, or be bolted, or clamped to the first and/or second guideway 41, 42.

A preferred embodiment shown in the figure provides a joining element 6 shaped like a “U” overturned by 180°.

Said joining element 6 preferably embraces the rail 4 on the outer sidewalls 45, 46 and extends above the rail 4, leaving free space for the movement of the pair of sliding elements 11, 12 of the trolley-mounted device 1.

In fact, the pair of sliding elements 11, 12 engages in support on the upper surface 411, 421 of the respective first and/or second guideway 41, 42 and it is therefore necessary that above the guideway 41, 42 there is a free space greater than the footprint of the sliding elements 11, 12.

Said sliding elements 11, 12 slide between the upper surface 411, 421 and the joining elements 6 along the track 4.

In order to facilitate washing and not to retain dirt, this joining element 6 is preferably made of open-section profiles.

For example, they could be metal sheets bent in a “U” shape.

The figure shows a possible embodiment in which the joining element 6 is obtained by welding together three metal sheets bent in a “U” shape.

In particular, the two side sheets have their wings facing outwards and the upper one has its wings facing downwards.

This embodiment is particularly simple and inexpensive to produce.

According to an aspect of the invention, the system 10 may comprise means 3 for supporting the track 4.

This allows for greater installation flexibility due to not being restricted by the structure of the plant in which the system 10 is installed.

In fact, in this way it is the support means 3 that are adapted to the plant, allowing a track 4 to be realized according to the path defined by the needs of the production process.

Said support means 3 may extend above the track 4 and/or along at least a portion of said track 4.

According to a preferred embodiment shown in the figure, the support means 3 are mechanically connected to the joining elements 6.

In particular, the support means 3 are placed above the joining elements 6.

They can be connected by fixing, preferably using bolts or clamps fastening.

Advantageously, as depicted in the figure, said support means 3 may comprise a first and a second support element 31, 32 arranged side by side in the transverse direction and preferably spaced from each other to form a gap S′.

Preferably said first and second support elements 31, 32 have a profile with an open cross-section.

In particular, said profile comprises a slot 31A, 32A preferably extending along the entire length of the first and/or second support element 31, 32.

Preferably said first and second support elements 31, 32 are arranged so that said slot 31A, 32A faces the outside of the support means 3.

For the same reasons as those given for the track 4, this embodiment of the support means 3 also facilitates cleaning along their entire extension without leaving closed areas where it is difficult to intervene.

According to a preferred embodiment, said first and second support elements 31, 32 have the same cross-sectional area as the first and second guideways 41, 42.

This solution optimizes the production costs of the system 10 and the procurement of the material required to produce it.

The figures show a preferred embodiment in which said first and/or second support element 31, 32 comprises a lower surface 312, 322 opposed and preferably parallel to the upper surface 311, 321.

Furthermore, preferably said lower surface 312, 322 and upper surface 311, 321, are connected to each other by a connecting surface 313, 323 arranged orthogonally to said upper surface 311, 321 and/or lower surface 312, 322.

In the support means 3, the side-by-side arrangement of the first and second support elements 31, 32 is preferably realized by arranging the connection surface 313 of the first support element 31 side-by-side with the connection surface 323 of the second support element 32.

In particular, the connection surface 313 of the first support element 31 and the connection surface 323 of the second support element 32 are spaced by the gap S′.

Optionally said first and/or second support element 31, 32 comprises a lip 314, 324 extending from the lower surface 312, 322 towards the upper surface 311, 321, defining the height of the opening 31A, 32A.

Optionally said first and/or second support element 31, 32 comprises a lip 314, 324 extending from the upper surface 311, 321 towards the lower surface 312, 322 defining the height of the opening 31A, 32A.

Accordingly, said first and/or second support elements 31, 32 may comprise two lips 314, 324 and be C-shaped, or no lips 314, 324 being shaped like a “U” turned by 90°, or with only one lip 314, 324 being shaped like the solution shown in the figures.

As depicted in the figures, said first and second support elements 31, 32 may comprise one or more reinforcing elements 33.

In fact, in addition to supporting the product and the frames, the support means 3 must also support the track 4.

Such reinforcing elements 33 may be inserted within its cross-section of the support element 31, 32, for example they may be plates welded to the inside of the cross section.

As depicted in the figures, said support means 3 include fixing means 35 for installation in the plant.

We will not go into the construction details of said fixing means 35 as they can be realized in various ways, especially depending on the type of structure present in the plant and to which they are to be attached.

An example is shown in the figure in which fixing means 35 exploit the gap S′ to connect to be connected to the support means 3.

According to an advantageous embodiment, as well as the track 4, also said support means 3 and/or said joining elements 6 are preferably made of stainless steel.

The subject matter of the invention is also the track 4 for systems 10 for the manual and/or automatic movement of frames in particular for moving and/or storing meat and/or cold cuts which provides for moving said frames from one location to another by hooking them to a trolley-mounted 1 device sliding along said track 4 made according to the characteristics previously described.

It in any case is intended for that described above to be given by way of non-limiting example; therefore, possible detail variants that may be required for technical and/or functional reasons are considered from now as to fall within the same protective scope defined by the claims below.

1. An overhead system (10) for manual and/or automatic movement of frames in particular for moving and/or storing meat and/or cold cuts, wherein said frames are moved from one location to another by hooking the frames to a trolley-mounted device (1) sliding along a track (4), said track (4) comprising a first and a second guideway (41, 42) arranged side-by-side in a transverse direction and arranged at a distance from each other to form a gap (S) sufficient to allow passage of at least one trolley-mounted device (1) slidably engaged on an upper surface (411, 421) of said guideways (41, 42) and protrude through the gap (S) below said guideways (41, 42) to receive the frames, and wherein said first and second guideways (41, 42) have an open cross-sectional profile comprising an opening (41A, 42A) and are arranged side-by-side so that said opening (41A, 42A) faces outwards, defining a track with open outer sidewalls (45, 46).

2. The overhead system (10) according to claim 1, wherein said first guideway (41) has an identical cross-sectional area as the second guideway (42).

3. The overhead system (10) according to claim 1, wherein said track (4) comprises the first and second guideways (41, 42) arranged mirrored with respect to an axis (Y) central to the gap (S).

4. The overhead system (10) according to claim 1, wherein said opening (41A, 42A) extends substantially along an entire length of said first and second guideways (41, 42).

5. The overhead system (10) according to claim 1, wherein the upper surfaces (411, 421) of the first and second guideways (41, 42) are arranged on a same plane.

6. The overhead system (10) according to claim 1, wherein at least one of said first or second guideway (41, 42) comprises a lower surface (412, 422) opposed to and parallel to the upper surface (411, 421), connected to each other by means of a connecting surface (413, 423) arranged orthogonally to at least one of said upper surface (411, 421) or lower surface (412, 422).

7. The overhead system (10) according to claim 6, wherein in said track (4) the connecting surface (413) of the first guideway (41) is flanked by the connecting surface (423) of the second guideway (42).

8. The overhead system (10) according to claim 1, wherein at least one of said first or second guideway (41, 42) comprises a lip (414, 424) extending from at least one of: the lower surface (412, 422) towards the upper surface (411, 421) defining the height of the opening (41A, 42A) or the upper surface (411, 421) towards the lower surface (412, 422) defining the height of the opening (41A, 42A).

9. The overhead system (10) according to claim 1, wherein at least one of said first or said second guideway (41, 42) is formed by a single piece by bending a metal sheet.

10. The overhead system (10) according to claim 1, wherein the trolley-mounted device (1) comprises at least one pair of sliding elements (11, 12) each adapted to be engaged resting on the upper surface (411, 421) of at least one of a respective first or second guideway (41, 42).

11. The overhead system (10) according to claim 1, wherein said track (4) comprises a plurality of joining elements (6) connecting the first guideway (41) to the second guideway (42) in a side-by-side position and configured to be engaged on the outer sidewalls (45, 46) of the track (4).

12. The overhead system (10) according to claim 11, wherein said joining element (6) is shaped like an upside-down U, which embraces the rail (4) on the outer sidewalls (45, 46) and extends above the rail (4), leaving free space for the movement of the pair of sliding elements (11, 12) of the trolley-mounted device (1).

13. The overhead system (10) according to claim 11, wherein said joining element (6) is made with open-section profiles to facilitate washing and to shed dirt.

14. The overhead system (10) according to claim 1, further comprising means for supporting (3) the track (4), extending at least one of: above the track (4) or along at least a portion of said track (4), being mechanically connected to the joining elements (6).

15. The overhead system (10) according to claim 14, wherein the support means (3) comprise a first and a second support element (31, 32) arranged side-by-side in a transverse direction and arranged spaced apart to form a gap (S′), wherein said first and second support elements (31, 32) have an open cross-sectional profile comprising a slot (31A, 32A) and are arranged so that said slot (31A, 32A) faces an exterior of the support means (3).

16. The overhead system (10) according to claim 14, wherein said first and second support elements (31, 32) have an identical cross-sectional area as the first and second guideways (41, 42).

17. The overhead system (10) according to claim 14, wherein said first and second support elements (31, 32) comprise one or more reinforcing elements (33) inserted within its cross-section.

18. The overhead system (10) according to claim 14, wherein said support means (3) comprise fixing means (35) for installation in a plant.

19. The overhead system (10) according to claim 1, wherein at least one of: the rail (4) or said support means (3), or said joining elements (6) are made of stainless steel.

20. The track (4) according to claim 1, for systems (10) for manual and/or automatic movement of frames for moving and/or storing meat and/or cold cuts which provides for moving said frames from one location to another by hooking them to a trolley-mounted device (1) sliding along said track (4).
